(19) United States
(12) Patent Application Publication
(10) Pub. No.: US 2002/0065723 A1
(43) Pub. Date: May 30, 2002

(54) Flexible reporting of customer behavior

(76) Inventors: Brian Anderson, Aptos, CA (US); Gregory P. Hassett, Paris (FR); John Watson, San Diego, CA (US); David Elderbrock, Madison, WI (US)

Correspondence Address: FRANK C. NICHOLAS, CARDINAL LAW GROUP, Suite 2000, 1603 Orrington Avenue, Evanston, IL, 60201, US

(21) Appl. No.: 10/050,640

(22) Filed: Jan. 16, 2002

Related U.S. Application Data
(63) Continuation of application No. 09/416,924, filed on Oct. 13, 1999.
Application No. 09/416,924 is a continuation-in-part of application No. 09/342,748, filed on Jun. 29, 1999.
Application No. 09/416,924 is a continuation-in-part of application No. 09/342,349, filed on Jun. 29, 1999, now abandoned.

(51) Int. Cl. G06F 17/60

(52) U.S. Cl. 705/14

(57) ABSTRACT

A method for tracking behavior which includes enabling a customer to view a plurality of online accounts, and enabling the customer to access the online accounts is provided. The method may include tracking the transaction history of each account; and providing flexible reporting to track customer events. The customer events may be customer transactions or customer purchases. The method may further include providing targeted email campaigns to the customer, and providing rewards to the customer based on the tracked customer events.

### CROSS-REFERENCE TO RELATED APPLICATIONS

This application is a continuation-in-part of assignee's pending applications U.S. Ser. No. 09/342,748, filed on Jun. 29, 1999, entitled “Affiliate Side Of Award Management System” and U.S. Ser. No. 09/342,349 filed on Jun. 29, 1999, entitled “User Side Of Award Management System.”

### FIELD OF THE INVENTION

The invention relates generally to establishing and maintaining loyalty reward plans, and in particular, to an automated method and device for maintaining a plan over the internet.

### BACKGROUND OF THE INVENTION

Loyalty reward programs, such as the frequent flyer programs sponsored by airlines, have become very popular. Sponsors of these loyalty programs encourage their customers to continue a relationship with them, by offering points that are awarded to customers each time the customers buy a product or a service from the sponsor. The customers, after accumulating a given number of points, can then redeem these points for awards.

The number of different loyalty programs now available makes it difficult and time consuming for a person who is a member of several different programs, to keep track of his or her points in each program. In addition, a member is unable to convert points from one program to another. Furthermore, an interactive user interface that permits both the sponsors and the members to issue and redeem points in real time is unavailable.

### SUMMARY OF THE INVENTION

A method for tracking behavior which includes enabling a customer to view a plurality of online accounts, and enabling the customer to access the online accounts is provided. The method may include tracking the transaction history of each account; and providing flexible reporting to track customer events. The customer events may be customer transactions or customer purchases. The method may further include providing targeted email campaigns to the customer, and providing rewards to the customer based on the tracked customer events.

### BRIEF DESCRIPTION OF THE DRAWINGS

The present invention is illustrated by way of example and not limitation in the figures of the accompanying drawings, in which like references indicate similar elements, and in which:

FIG. 1 shows one embodiment of the system for maintaining one or more loyalty plans.

FIG. 2 shows an embodiment of a member module.

FIG. 3 shows an embodiment of a client server network in which the present invention may be implemented.

FIG. 4 and 4B show an embodiment of a consumer managing one or more loyalty plans.

FIG. 5A shows an embodiment of the maximizer.

FIG. 5B shows an embodiment of redeeming points.

FIG. 6 shows an embodiment of an affiliate managing a loyalty plan.

FIG. 7 shows an embodiment of converting one type of redeemable loyalty points into another type of points.

FIG. 8 shows another embodiment of the system for maintaining one or more loyalty plans.

FIG. 9 shows an embodiment of a method for tracking behavior.

### DETAILED DESCRIPTION

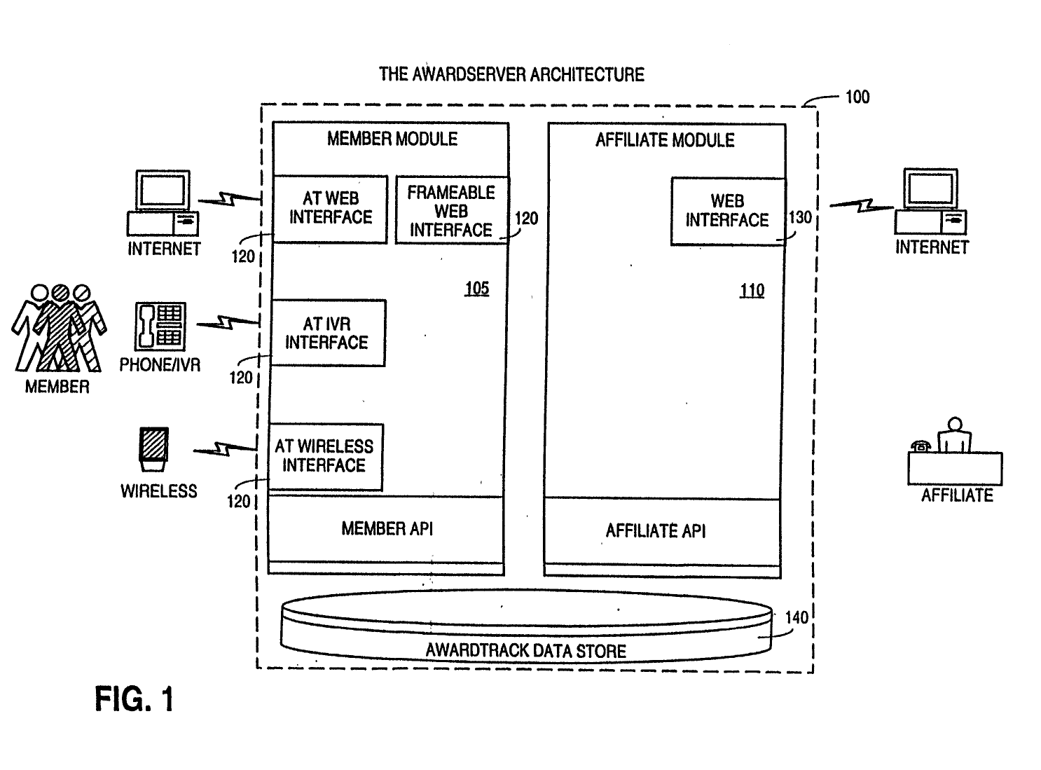

The invention includes two modules of the AwardTrack Loyalty Program Server 100. The two modules are the Member Module 105, and the Affiliate Module 110. FIG. 1 illustrates the place of these modules in the general AwardServer architecture. The member module 100 includes user interfaces 120. The affiliate module includes a web interface 130. The award server 100 also includes a database 140.

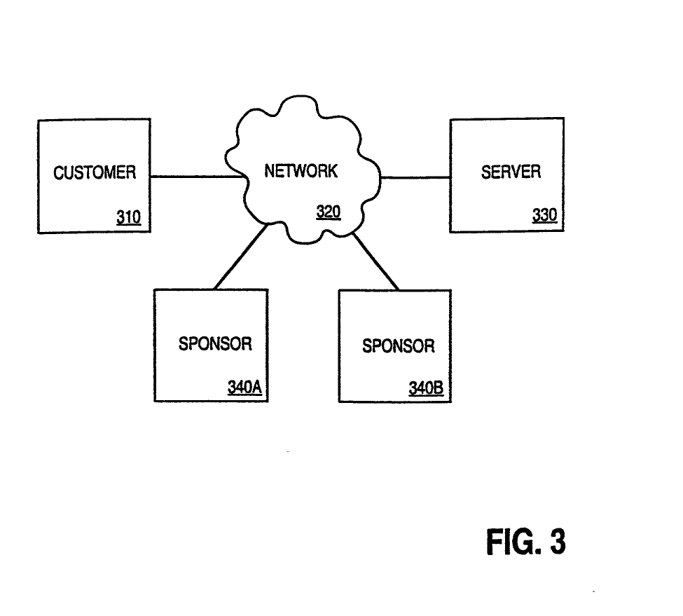

The invention consists of a method and system for maintaining a loyalty plan. The emerging use of electronic networking is enabling this type of plan to be made electronically from computers over remote connections. For example, a person who is a member of a loyalty plan can receive loyalty points by making a purchase using a personal computer 110, as shown in FIG. 3. Then, the person can send this purchase information over the internet 320, where it is received by a server 330. An affiliate, or sponsor of a loyalty plan, on the computer 440 connected to the server can then review the purchase, and respond immediately by awarding loyalty points to the consumer. The invention has the ability to integrate point redemption into an affiliate's e-commerce flow of an affiliate's website.

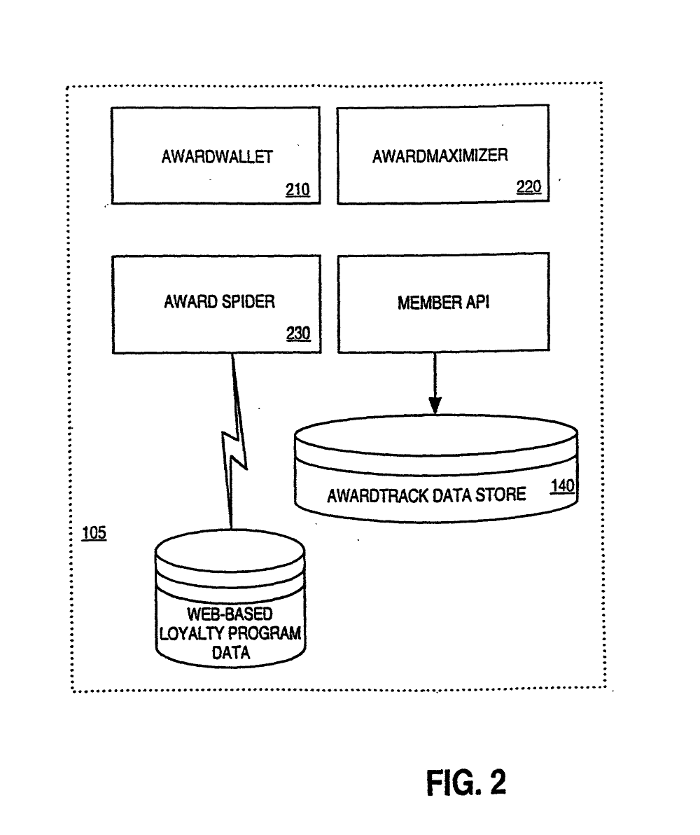

The Member Module 105 of the AwardServer consists of four main components, as shown in FIG. 2. A wallet 210 component is a loyalty program management tool, accessible via multiple interfaces. The maximizer 220 component is a tool that enables members to identify best values from their loyalty programs or plans. The spider 230 obtains loyalty program balance information from web-based loyalty program databases to update wallet automatically. The database includes a store 140, or redemption component, which includes an array of awards. Together, these four components permit a user of the present invention to earn, manage, and redeem points from one or more loyalty plans.

Users of the present invention can earn reward points through behavior. The behavior may include purchasing a product or service from a participating merchant. The purchase can be made by any method, including on-line, at a retail store, by telephone, or through the mail. In one embodiment, if the member makes a purchase on-line, with a credit card, a check the user's credit is performed, and an electronic purchase order is issued to the supplying company. After the purchase is made, the invention calculates the points awarded for the purchase, updates the award account of the enrolled user, and communicates that number of awarded points to the user. This point balance is updated and displayed at the browser in real time to the user.

The system and method of the present invention can handle rewards for behavior such as reading mail on a portal, or playing a game online, for example. Users of the present invention can also receive award points for any type of behavior. The behavior is rewarded with points in real time. A behavior can include any action taken by an end user which has been prepared, displayed and distributed through a given technology. The user responds to an event through the technology. For example, a user who reads an article on a web page, sends an email through a portal, clicks a banner, goes to a certain depth in a process, or spends a long time at a web site may be rewarded with points. Other examples include making a telephone call, then listening to an add by pressing a number on the telephone keypad. Negative behavior, such as refusing to read an article by selecting a “no thanks” icon may also be rewarded. Thus, the behavior that can be rewarded includes any action that a person does using a personal computer or a telephone.

A user can manage his or her loyalty programs with the wallet, spider, and maximizer components. The wallet is a management tool that allows users to check the balance information of their award points. The wallet stores information on the loyalty programs to which the user belongs.

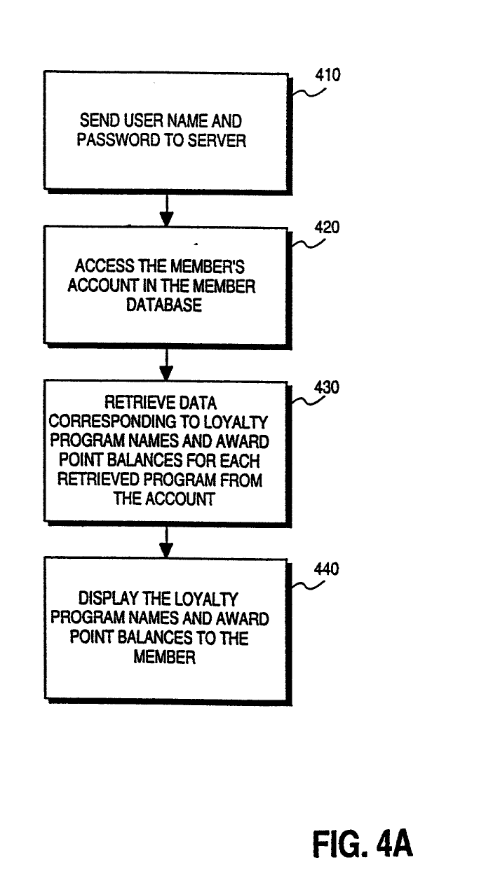

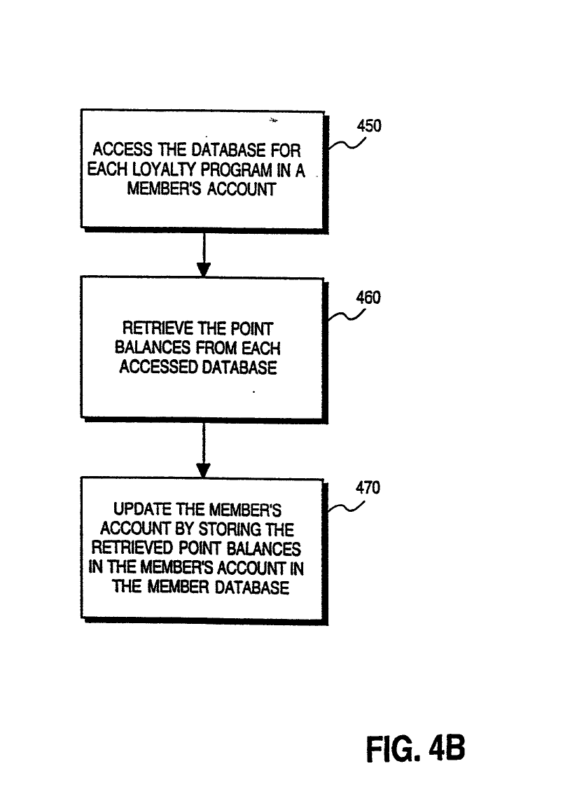

In one embodiment, a user interface, such as a general purpose computer having a web browser and access to the internet, for example, is provided to the member. The member uses the interface to execute the wallet point management feature by sending a user name and password over the internet to the server of the award member module, as shown in step 410 of FIG. 4A. The loyalty programs, including the reward point balances for each program, which are stored in a database on the server, are then accessed, step 420. The loyalty programs and balances for the user are retrieved from the database and sent to the wallet, step 430. The balances are displayed on the computer display by the wallet to the user as a summary award wallet page, step 440.

Another management tool for the present invention is the spider. This tool automatically updates the reward point balance information in the wallet by accessing loyalty program databases, as shown in FIG. 4B. The spider can automatically and electronically retrieve a user's point balances for many ; different loyalty programs, from a variety of on-line and off-line sources. These sources include on-line loyalty program databases, updates from affiliates, and called in status.

A loyalty program's database is contacted by the spider, step 450. Then, the program site is given user sign-on information by the spider. Reward point balance information is retrieved from the loyalty program's database, step 460, and stored in the member's account in the AwardTrack database, located at the server of the award member module, step 470. This balance information is also sent from the server to the wallet of the user, and the reward point balance information in the wallet is updated. The spider can be automatically run by the invention on a periodic basis, or the spider process can be initiated by the user.

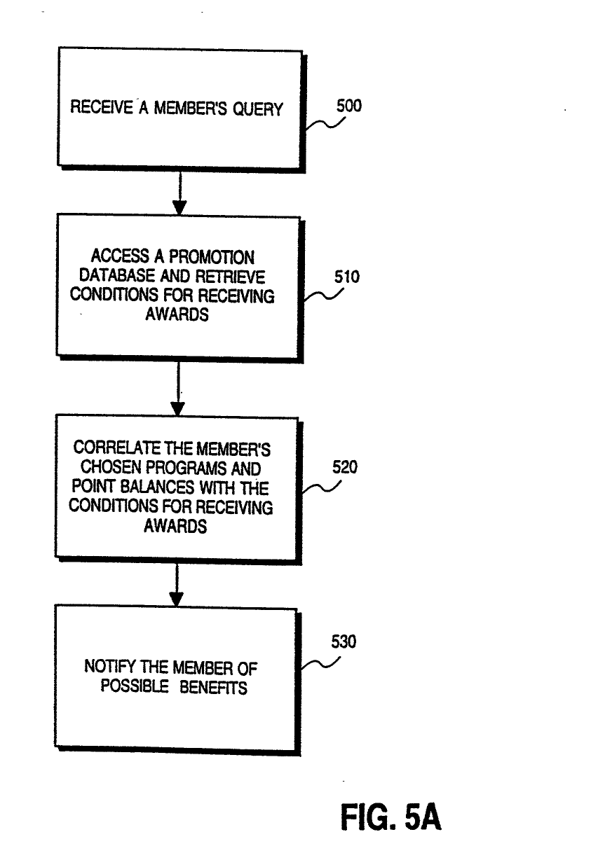

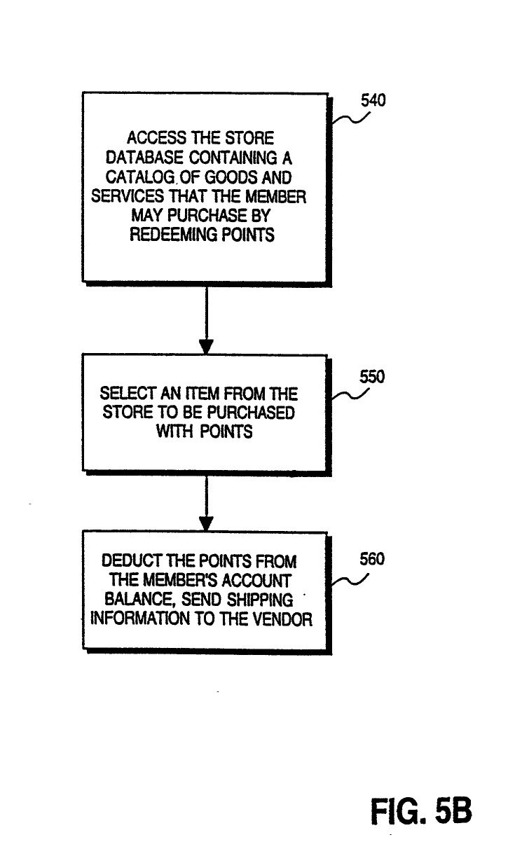

A third management tool is the maximizer. The maximizer, in real-time, can automatically maximize the awards that a user receives, as shown in FIG. 5A. The member sends a query that is received by the maximizer, step 500. The maximizer accesses-a promotions database and retrieves conditions for receiving awards, step 510. The maximizer correlates a member's chosen programs and point balances with a promotions database of possible awards and specific conditions for receiving those awards, step 520. Then, the maximizer can alert the member to possible benefits the member is close to receiving, step 530. Also, the maximizer can show the user how a specific benefit may be obtained more quickly by consolidating or trading different convertible points between programs.

The maximizer does more than simply correlate what points a user has in a rewards program with the rewards each program has and display to the user what the user can receive when the points are redeemed. In addition to telling a user what the user can buy or redeem with the rewards points, the maximizer can gather promotion items from the array of rewards, and convey to the user which items the user is close to being able to purchase by redeeming points. Here, the maximize function uses logic to determine what will, based on a user's history, be the most efficient way to reach the number of points needed.

Also, the maximizer can determine what, if any, promotions from other affiliates the member can take advantage of in order to acquire points from a specific affiliate. The maximizer also tracks the expiration dates, promotion codes and relation between loyalty programs. Thus, the maximizer can notify the end user that he or she will lose a benefit because promotions or miles are expiring.

Thus, this tool enables members to identify best values from their loyalty programs. The user executes this tool by selecting the maximize option from the wallet. Then, the member chooses options from the maximize query possibilities, including which categories to search for (airlines, hotels, merch., etc.), and whether or not to include wallet programs in consideration.

The maximizer query is run internally, selecting promotions (products and services that the points can be redeemed for). The information that can be searched by the maximizer can include several different options. One option can be a search in the member's chosen categories. Another is a search for promotions offered by only those companies to which the member belongs, or for only those items for which the member has points. The result of the query is displayed on a page.

The invention allows the member to redeem points on-line, and orders are placed real-time with vendors by using the store component. Enrolled users may browse through an array of awards and electronically redeem an amount of awarded points towards an award. The member logs on to the invention and views the wallet. The member then selects the store page, step 540 of FIG. 5B. The store page shows the member what his/her point balances are for each loyalty program, and what the points can be redeemed for. Several types of award points from several loyalty programs may be combined to redeem merchandise. For example, a given piece of merchandise may require 1000 AwardPoints and 500 American Aadvantage miles.

The member then selects an item from the store that he/she wishes to purchase with-the redeemable points from the loyalty program currency, step 550. The award store checks to make sure the member's point balance is sufficient to purchase the item with the points. The award store then deducts the points required to purchase this item or service from the user's point balance, and recalculates the member's point balance to reflect this purchase.

The invention stores the redemption order, automatically notifies the vendor of the valid order, and sends the vendor all necessary information for shipping, step 560. The vendor visits the award track site to search and mark the order as shipped. Large vendors can do this in batches. On receipt of notification from the vendor, the vendor is paid.

The user can access the wallet, maximizer, spider and store components through a user interface. Examples of a user interface include the internet using a web browser and an internet access provider; a telephone using either a touch tone device, or an interactive voice response (ivr) system; a wireless device; or any other user interface that is capable of accessing a digital database.

In one embodiment, the wallet, maximizer, spider, and store components are software programs that are stored in a computer readable memory and executed by a general purpose computer. The computer can be a server that is accessed by the member through a user interface that can establish a connection to the server. This connection may be established through any conventional means, including the internet, wireless telephone, and conventional telephone means.

The affiliate module permits affiliates to maintain loyalty programs. An affiliate is a company that offers membership to its customers in one or more loyalty programs. An affiliate can use the present invention to allow the management of rewards programs from the affiliate's own site, and to create and manage new rewards systems of its own. For example, an affiliate such as a travel agency could contact the AwardServer to query the number of points that a particular customer has in a particular loyalty program. Then, the affiliate can use this information to recommend less expensive travel options.

Any AwardTrack affiliate can benefit from issuing AwardPoints of the present invention to its customers. AwardPoints are a generic, convertible currency that can either be redeemed against a wide variety of merchandise, or converted into any of several participating airline travel programs. These programs include frequent flyer programs, such as those sponsored by American Airlines, United Airlines, and Delta Airlines. These loyalty marketing programs are not limited to airline programs, but include any loyalty programs offered by any merchants or affiliates. Further, an affiliate can create a customized co-branded point that can be redeemed only with the affiliate.

An AwardTrack affiliate can be active or passive. Passive affiliates sponsor loyalty programs that AwardTrack members choose to track in their AwardWallets. Passive affiliates typically do not redeem or issue points through the present invention. Active affiliates-are companies who use the present invention to maintain at least a portion of their customer loyalty program. If so, the loyalty program can be maintained in several ways.

First, the present invention may implement a plan where an affiliate chooses to purchase AwardPoints, which the affiliate will issue to its customers. Second, an affiliate may choose to serve as a redemption center, offering AwardTrack members an array of products and/or services that AwardTrack members may acquire by trading their AwardPoints, or other currency that the affiliate chooses to accept. Third, an affiliate may choose to design its own rewards system, defining its own point type, and its own redemption rewards.

The affiliate interface can perform the following functions: Enrolling members; Query customer information including which loyalty marketing programs he/she belongs to, and the balance information for each of these programs; Issue reward points to a customer and email reading is awarded; Redeem points for affiliate-provided goods or services; Query the number of points that the affiliate has remaining to issue to its customers; and Direct a customer to AwardTrack's redemption location where points can be redeemed or converted. Each of these features is now discussed in detail.

Users may enroll in one or more loyalty programs through several ways. In one embodiment, a user visits the web site for award track. If the user decides to join, the user clicks the enroll button that is displayed on the web site, and is placed at the enrollment page. Next, the user enters personal information, such as an email address, name, or any other pertinent information on the enrollment page. In order to complete the enrollment process, the user must select ‘Yes’ to an agreement that is presented to the user on the web site.

After receiving the enrollment-submission at the site internally, the affiliate module is used to add the new member. On the AwardTrack server, a record for the new member is added to the database, and an identification is assigned to the new user. The AwardTrack server sends the new member's identification back to the web site, where it is viewed by the new member.

In an alternative embodiment, the new member can enroll on an affiliate's site. First, the user visits the affiliate's site and decides to join AwardTrack. Then, pertinent information (e-mail, name, etc.) are entered on the affiliate's site. The affiliate sends the user's information to AwardTrack through a remote connection, such as the internet, for example. On the AwardTrack server, the new member record is added, and an ID is assigned to the new member. Through the remote connection, the AwardTrack affiliate module sends the affiliate the new member's ID. Finally, the Affiliate displays the member's information to the new member, and records the information in a database.

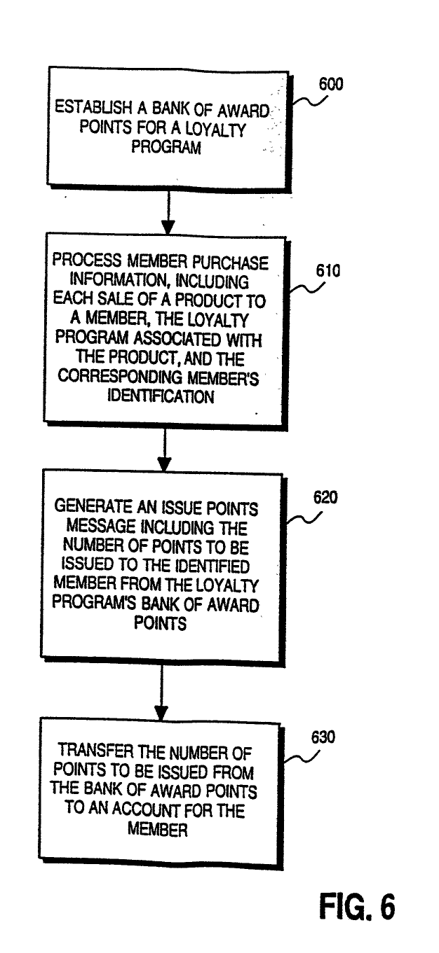

The Affiliate Module of the AwardServer can establish a bank of points for an affiliate, that the affiliate then awards to members of the affiliate's loyalty program for purchasing a given product or service, as shown in FIG. 6. Through AwardTrack, affiliates are sold blocks of points of a specified type: AwardPoints or the affiliates own point type. These blocks are the affiliate's bank of points, step 600. The points in this bank may expire after a given time period, in which case these points can no longer be issued to customers. The points may also have a time limit on when they are valid for redemption. The point blocks that are purchased by an affiliate are entered into the AwardTrack databases and may be confirmed by hand.

The affiliate module can issue points at an AwardTrack Merchant or Affiliate location. This can be done in person or via direct marketing (by phone, mail or web). The AwardTrack member identifies him or herself as a member and purchases an item or service from the affiliate. The affiliate records the AwardTrack member ID with the sale information in an automated or electronic fashion and can send this information in batch form to the affiliate module of the AwardTrack.

The affiliate module processes the batch information, which includes each sale of a product to a member, the associated loyalty program, and the corresponding member's identification, step 610, then generates an awards points message for each identified member, 620. To award points, the AwardTrack API checks to make sure the affiliate has a valid (and sufficient) block balance to issue the given number of points. For each member who is awarded points, the AwardTrack API deducts the number of points from the affiliate's point block. Then, it adds a detail entry for the newly awarded points for that loyalty program to the member's ledger, and updates the member's point balance, 630. The API sends a batch of messages back to the merchants or affiliates, stating that the points were issued to the identified members.

In an alternative embodiment, in real time, the affiliate processes an AwardTrack member's purchase. Via the AwardTrack API, the affiliate sends member information and the amount of points to issue to the AwardTrack affiliate module. The AwardTrack API checks to make sure the affiliate has a valid (and sufficient) block balance to issue the given number of points to the identified member. AwardTrack API deducts the number of issued points from the affiliate's point block. AwardTrack API adds a detail entry for the newly awarded points for the given loyalty program to the member's ledger, and recalculates the. member's point balance. The API sends a message back to the merchant or affiliate, that the points were issued to the appropriate member. Alternatively, the affiliate can establish rewards for behavior that is performed by an AwardTrack member. Via the AwardTrack applications program interface, selected behavior of a user is monitored by the affiliate. The affiliate then rewards the behavior of the user.

The affiliate module can also help members manage their account. The affiliate module does this by querying for member information, including which loyalty marketing programs the member belongs to, and the point balance information that the customer has for each of these loyalty programs. This information is sent to the AwardWallet feature on the member module.

The members check their balances with this feature in one of several ways. On the AwardTrack web site, the member logs in to the server. Via the API, all of the member's enrolled program names and balances are retrieved from the database, and sent to the wallet feature of the member module.

Alternatively, on an affiliate's site (which may be customized by the affiliate), the member logs in to the affiliate's web site. Via an API, the affiliate sends the member's id information to the affiliate module. Via an API, all of member's enrolled program names and balances are sent back to the affiliate's site. The affiliate displays the member's enrolled program names and balances to the member.

In another embodiment, on an affiliate's site (which may be customized by the affiliate), the member logs in to the affiliate's site. The affiliate's web site references a frame of the AwardWallet from the AwardTrack server. The Affiliate passes the member's ID in URL to the wallet. On the AwardTrack server, frame data is filled in by the wallet. Then, the frame with the account balance information appears on the affiliate's site.

The affiliate module can help a member redeem points for affiliate-provided goods or services. At the AwardStore or an Affiliate's redemption page, a member can make a choice for an item that the user desires to purchase by redeeming points. Then, an AwardTrack API call is made, containing data representing the member's ID, the item to be redeemed, and the redemption command. The AwardTrack API then checks the member's account database, to make sure the member has enough points in the account to purchase the desired item. If so, then the AwardTrack API deducts the points required to purchase the desired item or service from the user's account. Next, the member's point balance in his or her account is recalculated by the API. The redemption order is stored by the API. Finally, the AwardTrack API returns a message to the AwardStore or to the Affiliate's redemption page stating that the redemption is complete.

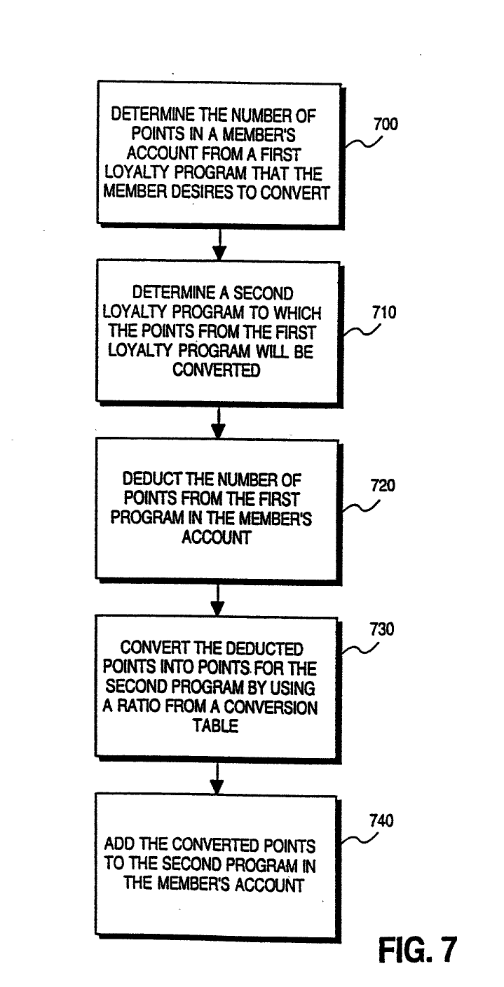

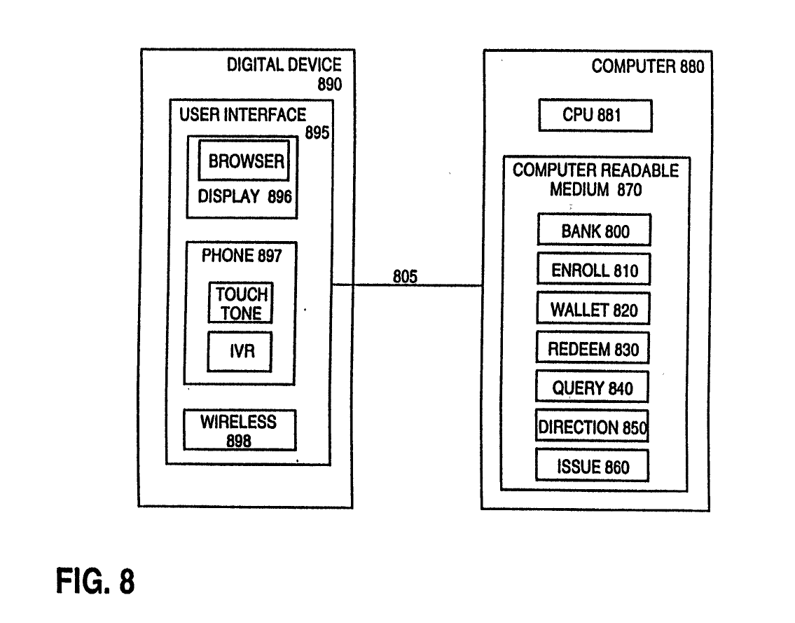

In addition to allowing a user to purchase an item by redeeming points, the Affiliate Module can assist the user with redeeming points by converting one type of point for another, as shown in FIG. 7. With certain point types, such as convertible points, for example, an amount of points can be converted, 700 (or redeemed) for a calculated number of points of another point type, 710. First, an API call, including data representing the member ID, the number of points to redeem, and the point type to be converted from and the point type to be converted to, is made.

The AwardTrack API checks the amount of points in the member's account to make sure member's point balance is sufficient to perform this conversion. The AwardTrack API also determines the ratio of the two point types from a conversion table, 730. Then, the AwardTrack API deducts the points from the first point type from the member's account, 720. The conversion in the point type is stored by the API in a detail log. AwardTrack API calculates, based on the conversion, what the amount of points are in the second point type. AwardTrack API adds the calculated points to the second point type balance, 740. AwardTrack API then recalculates the member's point balances. The AwardTrack API sends a message to the calling site/affiliate, stating that the conversion was successful.

The affiliate module can also help the affiliate determine how many points the affiliate has left to issue to customers. The affiliate module can query the number of points that the affiliate has remaining to issue to its customers. Via the AwardTrack API, the affiliate sends their own affiliate ID, password, and a command to retrieve their point block information. AwardTrack API checks to make sure the affiliate information is accurate. AwardTrack API looks up the affiliate's point block balance. API sends a message back to the affiliate with the point block balance.

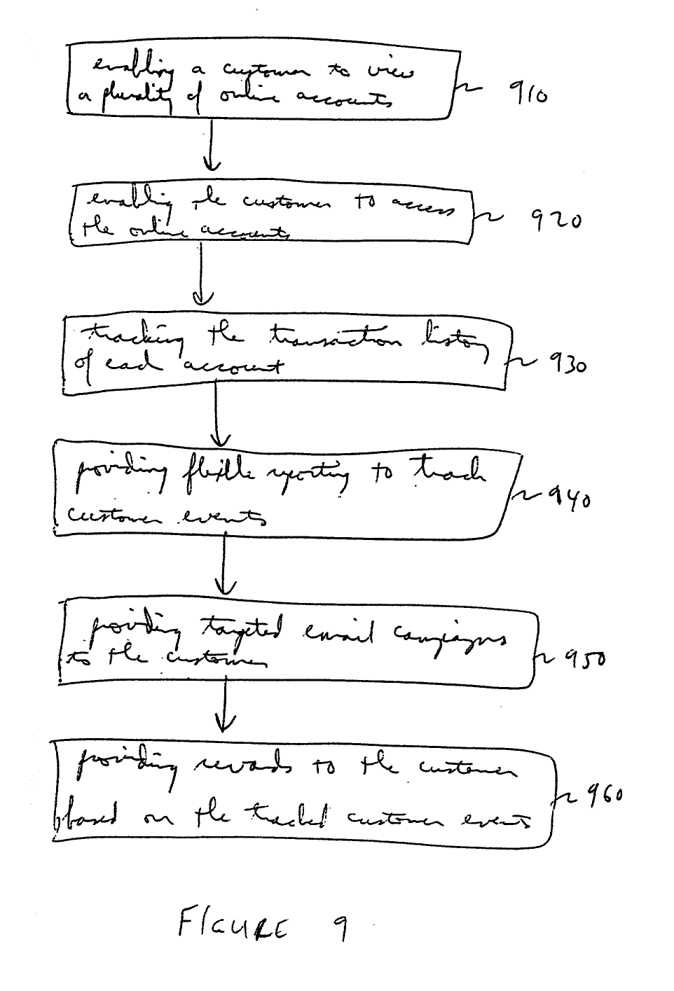

In one embodiment, as shown in FIG. 9, an affiliate module server can enable a merchant's Internet strategy more effective by helping the merchant's customers get online and then keeping them online. The customers will have no more hassle of dealing with traditional ways of accessing the information that matters to them the most. In this embodiment, the affiliate module enables a merchant to make it easier than ever for users to access their online personal account information from the convenience of their favorite site.

The affiliate module server may act as an agent to consolidate, organize and present consumers' personal account information for confidential viewing and access. Consumers will only have to remember one login and password to access all of their personal account information, thus fundamentally changing the way they use the Internet. For example, personal content and transactions have taken place with consumers face to face or through the mail, telephone or fax. The affiliate module server may be a virtual repository for the documents a consumer receives in the mailbox, while also acting as a venue to engage them in eCommerce.

This embodiment has several features. First, customers can view all their online accounts by making one easy login at the customer input terminal that establishes a network connection with the affiliate server, 910. The affiliate module can enable the merchant to provide customization to give the look and feel of residing at the merchant's site by incorporating background colors, font colors and more. A snapshot of all of the customer's personal accounts is stored in one place at the server. The accounts may include Banking; Investments; Credit Cards; Communications; Reward programs; and Bills. Customers may have access to over 100 online personal accounts.

An online demo and easy-to-use registration process is also provided. Customers may view an Account Summary screen of all online accounts: number of points earned, and balances remaining. An Account Detail screen for each account showing most recent transactions: transaction history, dates and descriptions may also be provided. The server may refresh account data to represent the most recent information available on the account provider site.

A quick link and quick login to account providers' websites to conduct transactions or to view more detailed information without having to login to multiple sites is provided, 920. The server may be used to enable the highest level of customer service tailored to match destination sites' customer care strategies, using a combination of toll-free service and email to assist with the registration process for first-time users and ongoing service support.

Flexible reporting to track user events, such as transactions or purchases, for example, may be provided. The user may be the merchant's customer, for example, 940. Targeted email campaigns to stimulate service usage and measure customer satisfaction may be provided to a merchant 950. These features enable a merchant to look at demographic information or a customer's transaction history and understand what customers are doing and what customer's want. The email campaigns can reward and provide information microbehavior of a customer. The merchant may also use the flexible reports to reward a customer for microbehavior. The merchant may provide rewards to the customer based on the tracked customer events, 960.

All of the functions that are performed by the affiliate can be a software program that is stored in a computer readable medium 870, and is executed by a general purpose computer 880. These software programs include programs for: Enrolling members 810; Query customer information including which loyalty marketing programs he/she belongs to, and the balance information for each of these programs 820; Issue reward points to a customer 860; Redeem points for affiliate-provided goods or services 830; Query the number of points that the affiliate has remaining to issue to its customers 840; and Direct a customer to AwardTrack's redemption location where points can be redeemed or converted 850.

The user, or the affiliate, or both, can access the affiliate module through a remote connection 805 with a digital device 890 having a user interface 895. Examples of a user interface include the internet using a web browser 896 and an internet access provider; a telephone 897 using either a touch tone device, or an interactive voice response (ivr) system; a wireless device 898; or any other user interface that is capable of accessing a digital database. Through the user interface, an affiliate or a member can cause the computer to execute the affiliate A functions stored in the computer readable medium 870.

### APPENDIX A

William E. Alford, Reg. No. 37,764; Farzad E. Amini, Reg. No. P42,261; Aloysius T. C. AuYeung, Reg. No. 35,432; William Thomas Babbitt, Reg. No. 39,591; Carol F. Barry, Reg. No. 41,600; Jordan Michael Becker, Reg. No. 39,602; Bradley J. Bereznak, Reg. No. 33,474; Michael A Bemadicou, Reg. No. 35,934; Roger W. Blakely, Jr., Reg. No. 25,831; Gregory D. Caldwell, Reg. No. 39,926; Ronald C. Card, Reg. No. P44,587; Thomas M. Coester, Reg. No. 39,637; Stephen M. De Klerk, under 37 C.F.R. § 10.9(b); Michael Anthony DeSanctis, Reg. No. 39,957; Daniel M. De Vos, Reg. No. 37,813; Robert Andrew Diehl, Reg. No. 40,992; Matthew C. Fagan, Reg. No. 37,542; Tarek N. Fahmi, Reg. No. 41,402; James Y. Go, Reg. No. 40,621; James A Henry, Reg. No. 41,064; Willmore F. Holbrow III, Reg. No. P41,845; Sheryl Sue Holloway, Reg. No. 37,850; George W Hoover II, Reg. No. 32,992; Eric S. Hyman, Reg. No. 30,139; Dag H. Johansen, Reg. No. 36,172; William W. Kidd, Reg. No. 31,772; Erica W. Kuo, Reg. No. 42,775; Michael J. Mallie, Reg. No. 36,591; Andre L. Marais, under 37 C.F.R. § 10.9(b); Paul A. Mendonsa, Reg. No. 42,879; Darren J. Milliken, Reg. 42,004; Lisa A. Norris, Reg. No. P44,976; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Kimberley G. Nobles, Reg. No. 38,255; Daniel E. Ovanezian, Reg. No. 41,236; Babak Redlaian, Reg. No. 42,096; William F. Ryann, Reg. 44,313; James H. Salter, Reg. No. 35,668; Wiliam W. Schaal, Reg. No. 39,018; James C. Scheller, Reg. No. 31,195; Jeffrey Sam Smith, Reg. No. 39,377; Maria McCormack Sobrino, Reg. No. 31,639; Stanley W. Sokoloff, Reg. No. 25,128; Judith A Szepesi, Reg. No. 39,393; Vincent P. Tassinari, Reg. No. 42,179; Edwin H. Taylor, Reg. No. 25,129; John F. Travis, Reg. No. 43,203; George G. C. Tseng, Reg. No. 41,355; Joseph A. Twarowski, Reg. No. 42,191; Lester J. Vincent, Reg. No. 31,460; Glenn E. Von Tersch, Reg. No. 41,364; John Patrick Ward, Reg. No. 40,216; Charles T. J. Weigell, Reg. No. 43,398; Kirk D. Williams, Reg. No. 42,229; James M. Wu, Reg. No. P45,241; Steven D. Yates, Reg. No. 42,242; Ben J. Yorks, Reg. No. 33,609; and Norman Zafman, Reg. No. 26,250; my patent attorneys, and Andrew C. Chen, Reg. No. 43,544; Justin M. Dillon, Reg. No. 42,486; Paramita Ghosh, Reg. No. 42,806; and Sang Hui Kim, Reg. No. 40,450; my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and James R. Thein, Reg. No. 31,710, my patent attorney.

### APPENDIX B

### Title 37, Code of Federal Regulations, Section 1.56 Duty to Disclose Information Material to Patentability

(a) A patent by its very nature is affected with a public interest. The public interest is best served. and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclosure information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclosure all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made or record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima fade case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

What is claimed is:

1. A method for tracking behavior comprising:
enabling a customer to view a plurality of online accounts; and
enabling the customer to access the-online accounts.

2. The method of claim 1 further comprising:
tracking the transaction history of each account.

3. The method of claim 2 further comprising:
providing flexible reporting to track customer events.

4. The method of claim 3 wherein
the customer events are customer transactions.

5. The method of claim 3 wherein
the customer events are customer purchases.

6. The method of claim 3 further comprising:
providing targeted email campaigns to the customer.

7. The method of claim 3 further comprising:
providing rewards to the customer based on the tracked customer events.

8. An article of manufacture comprising a computer readable memory having computer readable program code embodied thereon, which, when executed by a processing system, causes the system to perform the steps of tracking customer behavior, said computer readable program code comprising:
computer readable program code means for enabling a customer to view a plurality of online accounts; and
computer readable program code means for enabling the customer to access the online accounts.

9. The article of claim 8 further comprising:
computer readable program code means for tracking the transaction history of each account.

10. The article of claim 9 further comprising
computer readable program code means for providing flexible reporting to track customer events.

11. The article of claim 10 wherein
the customer events are customer transactions.

12. The article of claim 10 wherein
the customer events are customer purchases.

13. The article of claim 10 further comprising:
computer readable program code means for providing targeted email campaigns to the customer.

14. The article of claim 10 further comprising:
computer readable program code means for providing rewards to the customer based on the tracked customer events.
